(19) United States
(12) Patent Application Publication
(10) Pub. No.: US 2025/0241462 A1
(43) Pub. Date: Jul. 31, 2025

(54) Systems for Hanging Articles Relative to Surface

(71) Applicant: Barbara Anne Bailey Womble Bancroft, Dallas, TX (US)

(72) Inventor: Barbara Anne Bailey Womble Bancroft, Dallas, TX (US)

(21) Appl. No.: 19/075,658

(22) Filed: Mar. 10, 2025

Related U.S. Application Data
(63) Continuation-in-part of application No. 17/967,828, filed on Oct. 17, 2022, now Pat. No. 12,245,708.
Application No. 17/967,828 is a continuation of application No. 13/854,552, filed on Apr. 1, 2013, now abandoned.

(51) Int. Cl. A47F 5/08; A47G 25/06; A47G 25/20; A47G 25/40; A47G 25/74; F16B 2/08; F16L 3/02; F16L 3/08

(52) U.S. Cl. CPC A47F 5/0838; A47G 25/20; A47G 25/4053; A47G 25/0664; A47G 25/0685; A47G 25/0692; A47G 25/746; F16B 2/08; F16L 3/02; F16L 3/08

(57) ABSTRACT

A system for support and display of hanging articles and for mounting to a horizontal attachment surface. The system comprises: (i) a support arm having a length portion with a first end and a second end; (ii) multiple stays disposed at various locations along the support arm; and (iii) an attachment member configurable to variably fit either of a first size horizontal attachment surface or a second size horizontal attachment surface. A majority of the length portion extends in a descending and non-vertical direction away from the first end. Each stay, in the multiple stays, is configured to retain a portion of a hanger so as to impede the hanger from sliding in the descending and non-vertical direction.

### CROSS-REFERENCE TO RELATED APPLICATION

This application claims the benefit of and priority as a continuation-in-part to U.S. patent application Ser. No. 17/967,828, filed Oct. 17, 2022, which is hereby fully incorporated by reference herein in its entirety.

U.S. patent application Ser. No. 17/967,828 claims the benefit of and priority to U.S. patent application Ser. No. 13/854,552, filed Apr. 1, 2013, which is hereby fully incorporated by reference herein in its entirety.

### BACKGROUND OF THE INVENTION

Embodiments relate to a support system for hanging articles, and more specifically to a support frame for the consumer market and that can be mounted on a clothing bar or the like and proximate a surface, such as a nearby vertical wall or shelf.

Within the merchandising environment, various displays are used to hang articles such as clothing. A common display apparatus for hanging garments are clothing bars which are most typically straight or circular in order to display garments for sale. The clothing bars used in commercial environments typically have a rectangular profile while those available to the consumer market have a cylindrical profile. Certain commercial clothing bars may also employ support frames which are attached to the clothing bars in order to showcase or enable sorting garments by type. Although commercial bars have more structural variation than clothing bars manufactured for non-commercial use, because of proprietary design, parts associated with commercial assemblies such as support frames and other accessories are not interchangeable with systems from other makers or with clothing bars manufactured for the consumer market such as those often sold as part of a closet storage solution.

Clothing bars also may be used in residential situations, such as in a closet or the like. Here again, the clothing bar typically is cylindrical, and a user may hang traditional hangers or the like on such a bar, The traditional hanger often accommodates a single garment, and holds it parallel to similarly-situated garments on neighboring garments.

While the above approaches are known and have myriad applications, the present inventor has endeavored to improve the prior art, as further detailed below.

### SUMMARY OF INVENTION

In an example, there is a system for support and display of hanging articles and for mounting to a horizontal attachment surface. The system comprises: (i) a support arm having a length portion with a first end and a second end; (ii) multiple stays disposed at various locations along the support arm; and (iii) an attachment member configurable to variably fit either of a first size horizontal attachment surface or a second size horizontal attachment surface. Each stay, in the multiple stays, is configured to retain a portion of a hanger so as to impede the hanger from sliding in the descending and non-vertical direction.

Other aspects are described and claimed.

### BRIEF DESCRIPTION OF THE DRAWINGS

FIG. 1 is a perspective view of an article (e.g., garment) hanging system 100.

FIG. 2 is a side view of the FIG. 1 hanging system 100.

FIG. 3 is an enlargement of certain aspects of the hanging system 100.

FIG. 4 is an environmental view of the hanging system 100.

FIG. 5 is a front elevation view of the hanging system 100.

FIG. 6 is a rear elevation view of the hanging system 100.

FIG. 7 is a top view of the hanging system 100.

FIG. 8 is a bottom view of the hanging system 100.

FIG. 9 is a perspective view of an alternative article (e.g., garment) hanging system 900.

FIG. 10 is an enlargement of an attachment member.

FIG. 11 is a perspective view of an alternative article (e.g., garment) hanging system 1100.

### DETAILED DESCRIPTION OF THE INVENTION

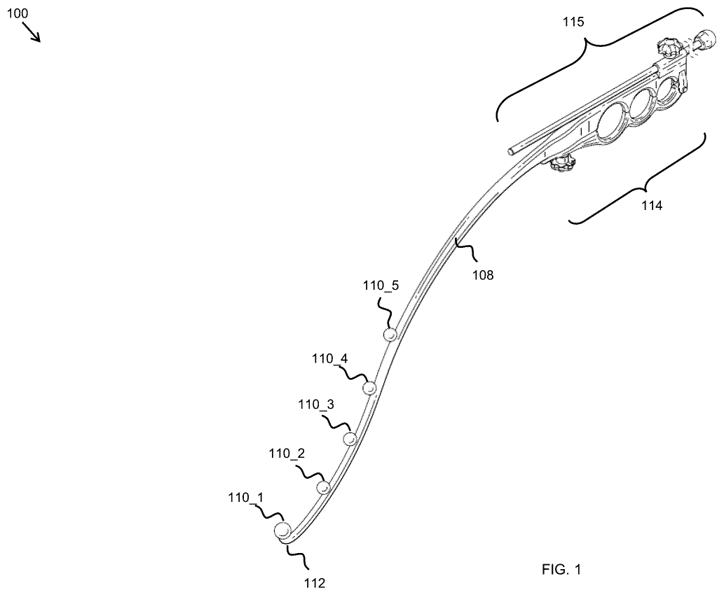

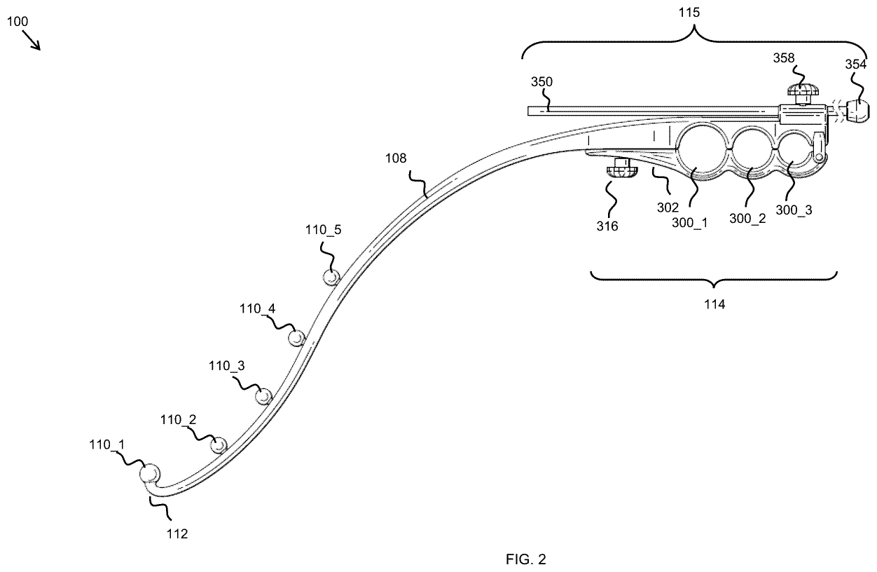

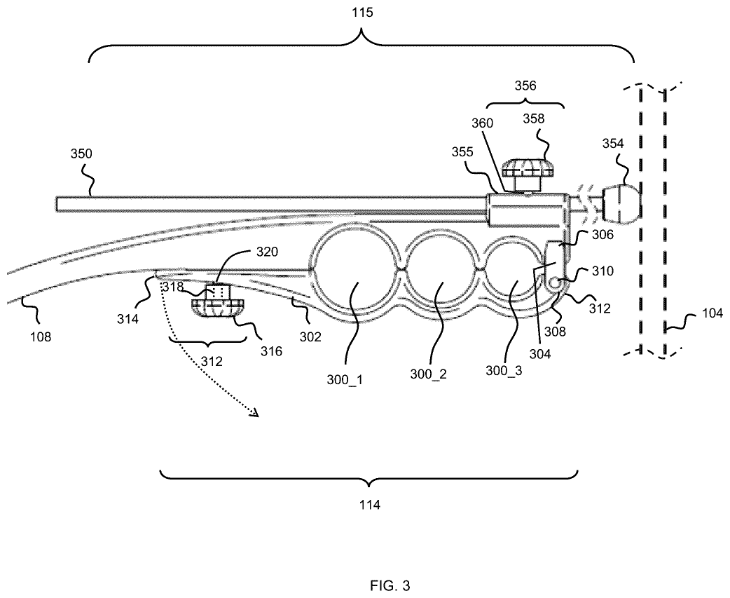

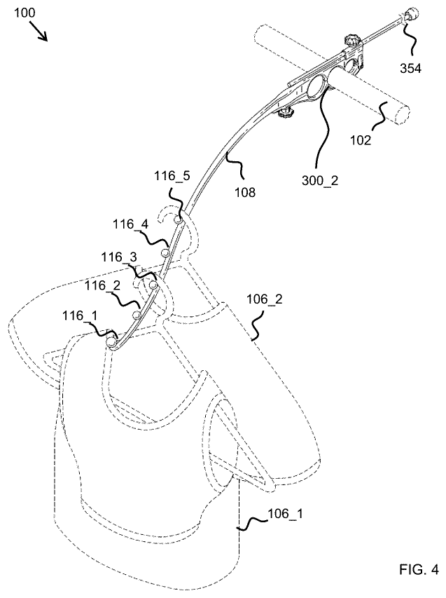

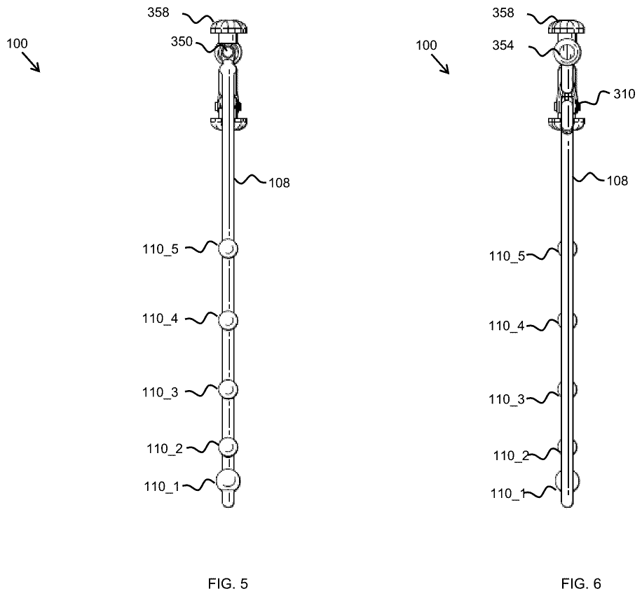

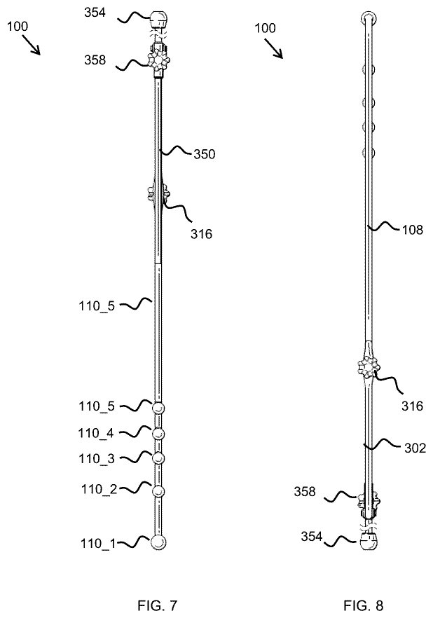

FIGS. 1 through 8 illustrate various different views of an example embodiment hanging system 100. The FIG. 1 orientation of the system 100 is representative of a positioning or orientation in which the system 100 may be mounted, relative to a horizontal attachment surface, for example provided as a cylindrical clothing bar 102 as shown in dashed lines in FIG. 4. The system 100 also may interface with an additional surface such as a wall 104, as shown in dashed lines in FIG. 3, or a nearby shelf as often is positioned near a clothing bar in a closet. As shown in FIG. 4, when the system 100 is properly supported, it may extend to support one or more items, such as clothing garments 106_1, 106_2, for example with each of the garments hanging from a respective clothing hanger.

The system 100 includes a support arm 108 and a plurality of stays 110_1 through 110_5, where the example illustrated has a total of five such stays (although other numbers may be implemented). Each of the support arm 108 and the stays 110_1 through 110_5 may be formed of a same and rigid material, for example of metal or plastic. In an example, the support arm 108 includes an arcuate shape. Further, the support arm 108 may descend from where it is mounted, but not directly vertically relative to where the support arm 108 attaches to the clothing bar 102 and/or the wall 104, for example such that a distal tip 112 of the support arm 108 is both vertically lower, but horizontally away from, a clothing bar attachment member 114 and a support mechanism 115, both formed at or near the opposing end of the support arm 108. In an example, a majority of the length of the support arm 108, between the attachment member 114 and the distal tip 112, has the arcuate shape and a length in a range of 20 to 24 inches. In an example, the arcuate shape includes two opposing radial portions, that is, a first downward-facing arc is provided closer to the clothing bar attachment member 114, and a second upward-facing arc is provided closer to the distal tip 112. Also in an example, a cross-section of the arcuate shaped portion may be generally cylindrical, with an increasing radius in the direction from the distal tip 112 toward the clothing bar attachment member 114, for structural, functional, and/or aesthetic reasons. Each of the stays 110_1 through 110_5 may have a same general shape, for example as a sphere attached to and protruding away from the support arm 108. In an example, the stay 110_1 located at or nearest the distal tip 112 is larger (e.g., has a larger diameter) than the other of the stays 110_2 through 110_5, for instance to support a particularly large hanger by the largest stay. Each of the stays 110_1 through 110_5 is separated by a distance (e.g., one to three inches from at least one more stay) and is oriented to extend away from the axial length of the support arm 108. This arrangement creates a respective physical interface 116_1 through 116_5, as shown in FIG. 4, between a respective stay 110_1 and 110_5, and the length of the support arm 108, and it also provides a distance between each of the interfaces 116_1 through 116_5. Accordingly, for each such physical interface, a portion (e.g., hook) of a hanger may rest at one of these physical interfaces and be maintained in that position by virtue of gravity acting on the hanger and positioning of the hanger hook at the physical interface, for example as shown in FIG. 4. This positioning thereby impedes the hanger from sliding in the descending and non-vertical direction along the length of the support arm 108. Moreover, this structure allows each of the garments (e.g., 106_1, 106_2) to hang from a different horizontal and relative position relative to the clothing bar 102, so as to reduce interference and/or binding, catching, or even appearance blocking between those garments. Accordingly, a user is provided various benefits, for example access, presentation, selection and the like.

FIG. 3 illustrates an enlarged view of the clothing bar attachment member 114 and the support mechanism 115, to assist in illustrating and describing certain of those apparatus.

As shown in FIG. 3, the clothing bar attachment member 114 includes a plural number of openings (or apertures), 300_1, 300_2, and 300_3, where for sake of example each of these openings has a same opening shape (e.g., circular), but has a differing dimensionality so that in total, the different options offered by the different sized openings permits a variably fit to one of different sizes (and/or shapes) of a clothing bar. For example, in FIG. 3, the opening 300_1 is the largest, the opening 300_3 is the smallest, and opening 300_2 has dimensions between that of the openings 300_1 and 300_3. For example in FIG. 3, the diameter of the opening 300_3 may be approximately 1.5 inches, the diameter of the opening 300_2 may be 1.25 inches, and diameter of the opening 300_1 may be 1.0 inches. Accordingly, each different size opening is compliant in dimensions to likewise accommodate a different size (e.g., different outer diameter) clothing bar that is slightly less than the size of the corresponding opening. Further, each of the openings, 300_1, 300_2, and 300_3 is formed by a first portion of the opening (shown along the top in FIG. 3) being provided by the support arm 108, and a second portion of the opening (shown along the top in FIG. 3) being provided by a pivoting frame 302. Accordingly, one section of the support arm 108 includes a set of three contours or areas defining the top of each of the openings 300_1 through 300_3, and similarly one section of the pivoting frame 302 includes a set of three contours or areas defining the bottom of each of the openings 300_1 through 300_3. Further, a pivoting member 304 is coupled between the support arm 108 and the pivoting frame 302, for example as implemented by an extension member 304 having a first end 306 affixed to a portion of the support arm 108, and having a second end 308 extended toward the pivoting frame 302, with a pin 310 through the second end 308 and also through a first end 312 of the pivoting frame 302. In this manner, as shown by a dashed curved arrow in FIG. 3, a second end 314 of the pivoting frame 302 may be moved in a downward fashion such that the pivoting frame 302 pivots about the pin 310, and whereby the pivoting frame 302 rotates counterclockwise about the pin 310. Also in this regard, a first release mechanism 312 is provided to couple the second end 314 of the pivoting frame 302 to the underside of the support arm 108. In an example, the first release mechanism 312 includes a knob 316 that is axially aligned with an interior threaded region 318 (shown in phantom) and that attaches to an extending threaded member 320 protruding from the underside of the support arm 108 and through a hole near the second end 314. As an alternative, the first release mechanism 312 may be fashioned as a set screw, with itself have an extending threaded member 320 protruding from the underside of the mechanism and that fits through a hole in the pivoting frame 302 and then threads into a female threaded hold in the underside of the support arm 108. In either instance, a threadable relationship exists between the first release mechanism 312 and the support arm 108, so as to either fix the pivoting frame 302 in place relative to the support arm 108, or to allow the two to separate from one another. In this manner, when a user of the system 100 desires to attach the system 100 to a clothing bar 102 such as in FIG. 4, the user turns the knob 316, for example counterclockwise causing the thread relationship to unscrew, and after sufficient turns the pivoting frame 302 and the support arm 108 separate from one another, thereby releasing the second end 314 of the pivoting frame 302 so as to allow the above-described counterclockwise rotation about the pin 310. With the pivoting frame 302 so pivoted, next the entirety of the system 100 may be positioned so that a clothing bar 102 is positioned to be fit or trapped within one of the plural openings (e.g., three) 300_1, 300_2, and 300_3—for example, in FIG. 4, the system 100 is illustrated as so positioned, relative to the medium-sized opening, namely, the opening 300_2. With the positioning achieved, the pivoting frame 302 is then returned to the position shown in FIG. 3 (or FIG. 4), and then the operation of the first release mechanism 312 is performed in opposite order, that is, the threaded relationship is aligned and the knob 316 is rotated clockwise so as to tighten the pivoting frame 302 relative to the support arm 108. In this manner, the clothing bar 102 is trapped within one the openings (e.g., the opening 300_2), so as to fix the length of the support arm 102 generally perpendicular to the clothing bar 102.

As also shown in FIG. 3, the support mechanism 115 includes an extendable member 350, for example formed with an extending (or telescoping) member 352 that includes a bumper 354 on one end thereof. In an example, the extendable member 350 passes through an interior of a collar 355 that is attached to the support arm 108, for example with the extendable member 350 and the collar 355 both being cylindrical, such that the outer diameter of the extendable member 350 is slightly smaller than the inner diameter of the collar 355. Further, a second release mechanism 356 may be coupled relative to the collar 355, where the second release mechanism 356 includes a knob 358 at its top and a protruding threaded member 360 at its bottom (e.g., in a set screw format). A tip (not separately shown) of the protruding threaded member 360 is fit or positioned through a threaded hole that passes through the outer diameter of the collar 355, and the tip then extends to contact the outer diameter of the extendable member 350, so that a compressive/retention force is applied to the extendable member 350 when the knob 358 is tightened. Accordingly, when the user desires to position the system 100, for example as shown in FIG. 4, the user loosens the knob 358 so that the extendable member 350 may slide within the collar 355, the extendable member 350 is then adjusted until a distal end of the bumper 354 contacts a touchpoint surface (e.g., the vertical surface of the wall 104; an underside of a shelf, etc.). In this regard, the bumper 354 is constructed of a non-marking or non-marring material, such as rubber. Once the bumper 354 is positioned to contact the touchpoint surface, the knob 358 is tightened so that the extendable member 350 is fixed in axial position. In this manner, gravity, along with the weight of any garment hanging on the support arm 108, pivots the entire system around the clothing bar 102 in a cantilever fashion, so that downward force along one or more of the stays 110_1 through 110_5, either from gravity or garment weight, causes a downward force near the distal tip 112 and, in opposite fashion, an upward force on the bumper 354, thereby maintaining the bumper 354 in contact with the touchpoint surface.

FIG. 4 is an environmental view of the hanging system 100, illustrating various of the aspects described earlier. Accordingly, in FIG. 4, the user positions the system 100 so that the attachment member 114 is coupled to the clothing bar 102 by selecting an appropriately sized one of the plural openings and trapping the clothing bar 102 in that opening, where in the illustrated example the selected one is the opening 300_2. If the clothing bar 102 had a smaller diameter, then it could be entrapped alternatively in the opening 300_3, and if it has a larger diameter, then it could be entrapped alternatively in the opening 300_1. The bumper 354 is also shown, and could be extended to contact a surface, for example as shown in FIG. 3. With either or both couplings (to the clothing bar and/or contacting a surface), the support arm 108 extends to support one or more items, such as clothing garments 106_1, 106_2, for example with each of the garments hanging from a respective traditional clothing hanger. As a result, each traditional hanger on the support arm 108, and the garment it supports, can be positioned away from the clothing bar 102 and also away from any traditional hangers or items hanging on the clothing bar 102. This permits such garments to be more readily visible, available, and selectable to the user, for display, choice, protection, or the like.

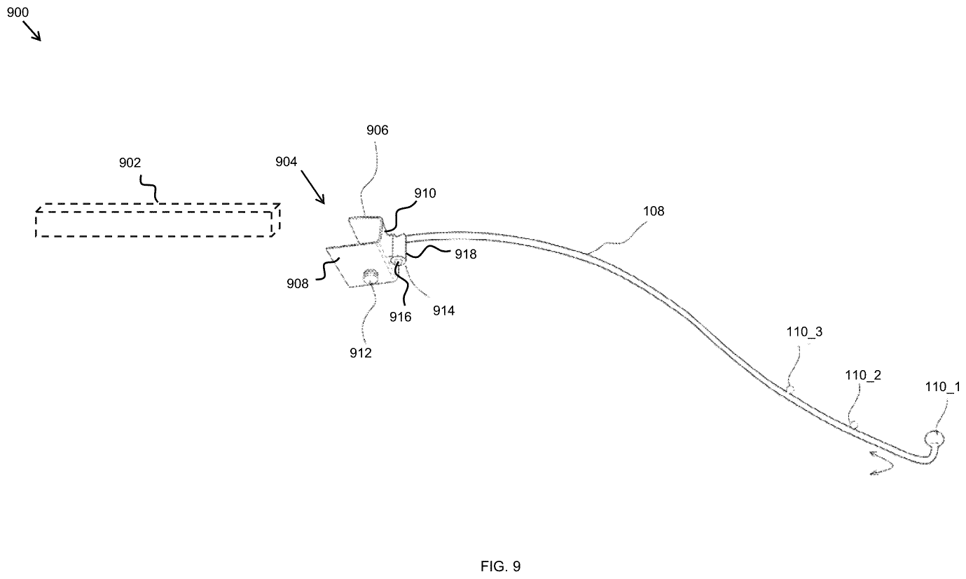

FIG. 9 is a perspective view of an alternative article (e.g., garment) hanging system 900. The FIG. 9 orientation of the system 900 is representative of a positioning or orientation in which the system 900 may be mounted, relative to a shelf 902, shown to the left of the system 900 so that, as shown, the two are not yet attached to each other. The shelf 902 is typically oriented in a relatively horizontal position, as may be mounted in a closet, which may or may not include a clothing bar also in proximity to (e.g., parallel to and below) the shelf 902. The system 900 includes a support arm 108 and a plurality of stays 110_1 through 110_3, where the example illustrated has a total of three such stays (although other numbers may be implemented).

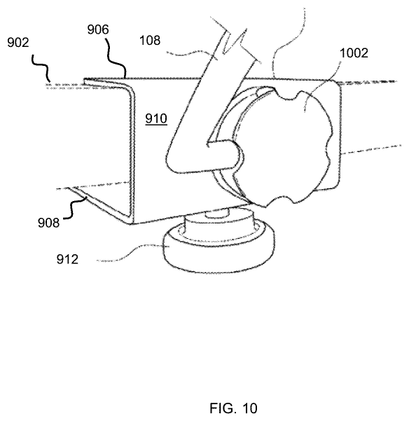

The system 900 also includes an attachment member 904 for coupling the system 900 to the shelf 902. The attachment member 904 includes a top plate 906, a bottom plate 908 parallel to the top plate 906, and a vertical plate 910 connected along a first edge to one edge of the top plate 906 and along a second edge, opposite the first edge, to one edge of the bottom plate 908. The attachment member 904 also includes a compression apparatus 912 that may fit through the bottom plate 908 so as to apply a compression force against a surface (e.g., underside) of the shelf 902 and thereby urge the opposite shelf surface (e.g., topside) against the top plate 906, so as to retain the attachment member 904 affixed to the shelf 902. For example, the compression apparatus 912 may include a knob and threaded member relationship, comparable in various respects to FIG. 3 knob 358, as also shown in FIG. 10, whereby the threaded member extends through the bottom plate 908 and makes contact with a surface of the shelf 902. The attachment member 904 also includes a pivot apparatus 914 (e.g., a pin 916 or end of the support arm 108, within a collar 918), so that the support arm 108 may rotate relative to the plane of the vertical plate 910. Accordingly, the support arm 108 can rotate around its first end, or the pivot apparatus 914, independently of whether the attachment member 904 is fixedly coupled to the shelf 902.

FIG. 10 is an enlargement of an attachment member 904 and a portion of the support arm 108, attached to an edge of a shelf 902. A pivot hinge 1002 includes an aperture that a section of the support arm 108 fits within to permit the support arm 108 to pivot away from a perpendicular orientation relative to the edge of the shelf 902.

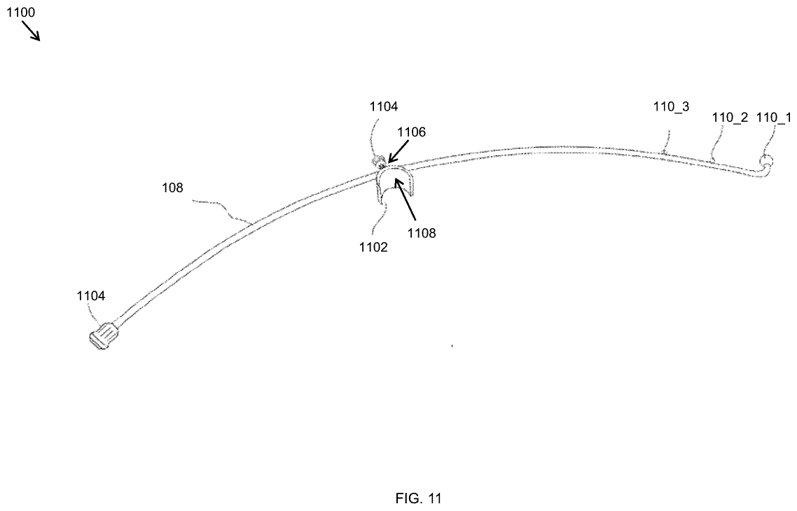

FIG. 11 is a perspective view of an alternative article (e.g., garment) hanging system 1100. The hanging system 1100 includes a partially open-ended (e.g., semi-cylindrical) attachment member 1102 that is shaped to rest along a portion of the outer surface of a clothing bar (e.g., not shown, for example installed in a closet). In a normal use, the end of the arm 108 with stays 110_1, 110_2, 110_3 projects outwardly from the clothing bar, while the opposite end of the arm 108 possesses a bumper 1104 (e.g., rubber) braced against the wall of a closet or a nearby shelf (e.g., the shelf underside). The bracing effect permits the clothing bar to support the weight of several garments facing out to assist in garment selection. The amount of arm 108 projecting from either the front or back can be adjusted by adjusting a tightening member 1104 which is shown as a set screw that when loosened permits the arm 108 to slide back and forth through a collar 1106 on the backside of the attachment member 1102. Preferably, the attachment member 1102 is lined with a material 1108 of any suitably non-marring material such as a rubber or felt pad. In effect, the arm 108 is supported superiorly to the closet rod and can be easily installed thereon and removed. Weight of the garments increases the inertia of the arm by forcing bumper 1104 against a back wall or against the underside of a closet shelf.

From the above, one skilled in the art should understand and appreciate that embodiments provide a support system for hanging clothing articles and the like, that can be mounted on a clothing bar or the like and proximate a surface, such as a nearby wall or shelf. The system includes a support arm that extends away from the clothing bar, and a number of stays on the support arm so that clothing articles may be hung at one or more of the stays, with the clothing thereby oriented for example perpendicular to the support arm. In this manner, each clothing article can be positioned away from the clothing bar, and also away from any traditional hangers or items hanging on the clothing bar. Further, the system includes variability for use with different size, or shape, attachment surfaces such as clothing bars and further oriented relative to different nearby structures, such as a wall or shelf. Further, while certain aspects have been shown and/or described, still others are contemplated or will be ascertainable to one skilled in the art, given the inventive teachings of this document. For example, types of stays, other than spheres, may be implemented. Thus, while features have been described to serve to illustrate the inventive scope as have been demonstrated by certain embodiments, one skilled in the art will appreciate that the scope is further subject to various modifications, substitutions, or alterations, without departing from that inventive scope. Still other examples will be ascertainable by one skilled in the art given the teachings herein and as further guided by the following exemplary but non-exhaustive claims.

What is claimed is:

1. A system for support and display of hanging articles and for mounting to a horizontal attachment surface, the system comprising:
a support arm having a length portion with a first end and a second end;
multiple stays disposed at various locations along the support arm; and
an attachment member configurable to variably fit either of a first size horizontal attachment surface or a second size horizontal attachment surface;
wherein a majority of the length portion extends in a descending and non-vertical direction away from the first end; and
wherein each stay, in the multiple stays, is configured to retain a portion of a hanger so as to impede the hanger from sliding in the descending and non-vertical direction.

2. The system of claim 1 wherein the attachment member comprises structure including a first aperture having a first inner dimension and a second aperture having a second inner dimension, differing from the first inner dimension.

3. The system of claim 2, wherein the first size horizontal attachment surface comprises a first clothing bar having a first outer dimension compliant with the first inner dimension and wherein the second size horizontal attachment surface comprises a second clothing bar having a second outer dimension compliant with the second inner dimension.

4. The system of claim 3, wherein each of the first clothing bar and the second clothing bar comprises a cylindrical clothing rod.

5. The system of claim 1, wherein the attachment member comprises a first contoured member separably attached to a second contoured member, wherein manipulation of the first contoured member relative to the second contoured member entraps the horizontal attachment surface between the first contoured member and the second contoured member.

6. The system of claim 5 and further comprising a releasing mechanism for selectively coupling, and releasing, a position of the first contoured member relative to the second contoured member.

7. The system of claim 5, wherein the first contoured member is pivotally attached to the second contoured member.

8. The system of claim 1, wherein the attachment member comprises a first contoured member pivotally attached to a second contoured member, wherein manipulation of the first contoured member relative to the second contoured member entraps the horizontal attachment surface in an aperture formed between the first contoured member and the second contoured member.

9. The system of claim 1, wherein a majority of the length portion comprises an arcuate shape.

10. The system of claim 1, wherein the attachment member is further configurable to variably fit either of a first size horizontal attachment surface, a second size horizontal attachment surface, or a third size horizontal attachment surface.

11. The system of claim 10 wherein the attachment member comprises structure including a first aperture having a first inner dimension, a second aperture having a second inner dimension, differing from the first inner dimension, and a third aperture having a third inner dimension, differing from the first inner dimension and the second inner dimension.

12. The system of claim 11, wherein the first size horizontal attachment surface comprises a first clothing bar having a first outer dimension compliant with the first inner dimension, wherein the second size horizontal attachment surface comprises a second clothing bar having a second outer dimension compliant with the second inner dimension, and wherein the third size horizontal attachment surface comprises a third clothing bar having a third outer dimension compliant with the third inner dimension.

13. The system of claim 1, wherein the attachment member comprises a slidable member having a tip for bearing against a surface reachable by extension of the slidable member and proximate one of either the first size horizontal attachment surface or the second size horizontal attachment surface.

14. The system of claim 1, wherein the surface comprises either a shelf or a wall.

15. The system of claim 1, wherein the attachment member comprises:
a first contoured member pivotally attached to a second contoured member, wherein manipulation of the first contoured member relative to the second contoured member entraps the horizontal attachment surface between the first contoured member and the second contoured member; and
a slidable member having a tip for bearing against a surface reachable by extension of the slidable member and proximate one of either the first size horizontal attachment surface or the second size horizontal attachment surface.
